(19) United States
(12) Patent Application Publication
(10) Pub. No.: US 2005/0004736 A1
(43) Pub. Date: Jan. 6, 2005

(54) Vehicle ground speed control system

(76) Inventors: Jack T. Belcher, Blountville, TN (US); Wayne D. Farmer, Abingdon, VA (US)

Correspondence Address: Donald W. Spurrell, P.O. Box 970, Johnson City, TN, 37605, US

(21) Appl. No.: 10/836,742

(22) Filed: Apr. 30, 2004

Related U.S. Application Data
(60) Provisional application No. 60/466,752, filed on Apr. 30, 2003.

(51) Int. Cl. G06F 17/00

(52) U.S. Cl. 701/50; 701/93

(57) ABSTRACT

A method and apparatus for controlling engine rpm and thus the real time ground speed or real time implement operating speed, each hereinafter referred to as “real time operational speed”, of industrial and off highway vehicles thru the use of an electronic control module (ECM) and sensory means including speed sensors, which sensors transmit electrical, mechanical, electro-mechanical or other signals to the (ECM) of said real time operational speeds of the vehicle to control via the (ECM), the vehicle ground speed in accordance with pre-set safety or other operational requirements programmed into the (ECM).

### BACKGROUND OF THE INVENTION

This application claims priority under 35 U.S.C. 119(e)(1) based on Applicant's Provisional U.S. patent application Ser. No. 60/466,752, filed Apr. 30, 2003 and titled “VEHICLE GROUND SPEED CONTROL SYSTEM”.

Field: The present invention concerns a speed control system for industrial and off-the road type vehicles for improving the safety thereof, particularly of fork lifts and the like which lift heavy loads to heights which can generate instability of the vehicle under certain roadway or other operating conditions.

In the operation of, e.g., fork trucks or lifts, and tow tractors or the like, various roadway conditions are typically encountered such as unevenness of the floor, road or terrain, or obstructions located in the roadway, or actual inclines of the roadway. The present invention provides means for taking into account these various conditions and controlling the vehicle road speed and/or the operating speeds of auxiliary implements in accordance with preestablished operational parameters.

The manufacturers of industrial equipment, particularly vehicles, have long been plagued with liabilities and law suits from operators who operate equipment in unsafe manners. Factories, warehouses, and distribution centers and networks commonly have vehicle speed limits either posted or mandated in their operations manuals which the operators often ignore. The ground speed at which these vehicles, particularly industrial trucks such as forklifts are operated have typically relied on the operator judging if their speed is within the limits.

Prior Art: Industrial trucks, e.g., fork trucks and tow tractors typically have been provided with some type of engine rpm governing mechanism. The types of governors utilized most often have been either a belt driven mechanical governor or an air velocity governor. Once adjusted, these devices limit the maximum rpm of the engine. This adjustment typically was the way in which the maximum ground speed was limited in operation, however this created other issues relating to the usefulness of the equipment in several ways described below.

1. Both types of said governors operate via cams, springs and levers. Operators constantly defeated these features by simply adjusting the mechanism by using simple hand tools, thus potentially allowing operation in an unsafe manner such as excessive vehicle speeds at dangerous road or load conditions, thus increasing manufacturers and companies liabilities.

2. Once adjusted to lower the maximum ground speed, the speed at which optional accessories could be utilized was also decreased. This impairs cycle times for required operations, thus decreasing productivity.

3. Restricting the maximum engine rpm reduces the horse-power available to transmissions and auxiliary power devices, e.g., hydraulics. This reduction in turn prohibits the vehicle's ability to climb inclines, loading ramps, or any other type of grade as well as reducing the power available for auxiliary devices.

The present invention (system) corrects these deficiencies while still providing speed limiting. The present electronic control unit (ECU) utilizes various operating conditions inputs from the engine, from the operator and from a vehicle ground speed sensing device and/or an implement operating speed sensing device and processes the inputs to control the engine rpm to maximize vehicle operation and performance. In the present system, the operator sends a speed demand or request to the ECU via a sensor input such as an accelerator pedal position sensor. The ECU processes this demand and commands the electronic throttle motor or actuator to move the throttle plate to the desired position to control intake air flow and thus engine rpm. The engine rpm, via programmed algorithms in the ECU, constantly compares the inputs received from the ground speed and other sensing devices. Once the programmed ground or other speed limit (maximum) is achieved, the ECU processes the data via the programmed algorithms to control (govern) the electronic throttle motor to maintain this maximum speed. Should the operator relax the pedal position as a demand to slow the engine and the aforesaid speeds, the electronic pedal position sensor will signal the ECU to actuate the throttle motor to reposition the throttle blade to slow the engine and vehicle or other operating speeds in accordance with the operators demand.

On inclines, the present system allows the engine's maximum available power to be delivered upon request from the operator. Again, algorithms compare this to maximum speed limits. This allows the vehicle to climb ramps utilizing the full power from the engine. Production is thus increased and cycle times decreased. As this system is electronically controlled by the ECU, any and all adjustments must be performed via electronic interfaces and software which prevents operator tampering.

### SUMMARY OF THE INVENTION

A method and apparatus for controlling engine rpm and thus the real time ground speed or real time implement operating speed, each hereinafter referred to as “real time operational speed”, of industrial and off highway vehicles thru the use of an electronic control module (ECM) and sensory means including speed sensors, which sensors transmit electrical, mechanical, electro-mechanical or other signals to the ECM) of said real time operational speeds of the vehicle to control via the (ECM), for example, the vehicle ground speed in accordance with pre-set safety or other operational requirements programmed into said (ECM).

In one preferred embodiment, the present method comprises the steps of:

(1) providing on a vehicle using either liquid fuel or LP gas, an (CM) which is programmed to receive electronic signals of various real time operational speeds of a vehicle and correlate then with desired operational speeds of said vehicle and with limiting operational speeds which are pre-programmed into said (ECM), wherein said vehicle is powered by an internal combustion engine provided with an accelerator device, a throttle plate and an electronic governor mechanism which can, upon receiving an electronic signal from said (ECM), adjust the throttle plate position to regulate air flow to the engine and thus control engine rpm;

(2) sensing desired operational speeds sought by the vehicle operator thru the position of an accelerator means managed by the operator, and transmitting signals representative of said position to said (ECM);

(3) sensing real time operational speeds and transmitting signals representative thereof to said ECM);

(4) as desired, sensing any other real time operational states of said vehicle or of a load, obstruction or the like in contact with said vehicle and transmitting signals representative thereof to said (ECM); and

(5) causing said (ECM) to correlate said signals of real time operational speeds with said desired operational speeds and with said limiting operational speeds generate and transmit signals to said governor mechanism to adjust the throttle plate position to allow a certain air flow to said engine to attain desired engine rpm and thus desired real time operational speeds.

In the above preferred embodiment, the various signal sources utilizable are all of those which affect or are affected by vehicle speed and engine performance and include, for example, engine t, fuel t and P, manifold absolute pressure (MAP) engine rpm, intake air flow speed, road resistance such as smooth or mud or grade, wheel load, fork lift or bucket load and/or fork lift or bucket height, those required by Federal safety regulations for vehicle operation, and those sources desired for safety considerations such as, e.g., excessive tilting of lift forks or personnel lifting platforms.

It is, of course, apparent that the present system is a dynamic one and is designed such that the various sensors are transmitting signals to the (ECM) in a substantially constant, real time, manner, e.g., at least at fractional to microsecond intervals in order not to miss any abnormal or dangerous state of the vehicle or of any item or structure with which the vehicle comes into contact. Any type of sensors and microprocessors (ECM) known to the trade may be employed in the present invention.

### BRIEF DESCRIPTION OF THE DRAWINGS

The invention will be further understood from the following description and drawings wherein:

FIG. 1 is a schematic of a preferred embodiment of the present overall real time operational speed control system which can be utilized on a fork lift truck;

FIG. 2 is a cross-section of an LP (propane) injector fed carburetor useful in the present invention showing the throttle plate closed;

FIG. 3 is a partially broken away view taken along line 3-3 in FIG. 2 showing the throttle plate wide open;

FIG. 4 is a cross-sectional view of the LP (propane) injector shown in FIG. 2; and

FIG. 5 is a side view of an accelerator pedal useful for the present invention and having a potentiometer type pedal position sensor device.

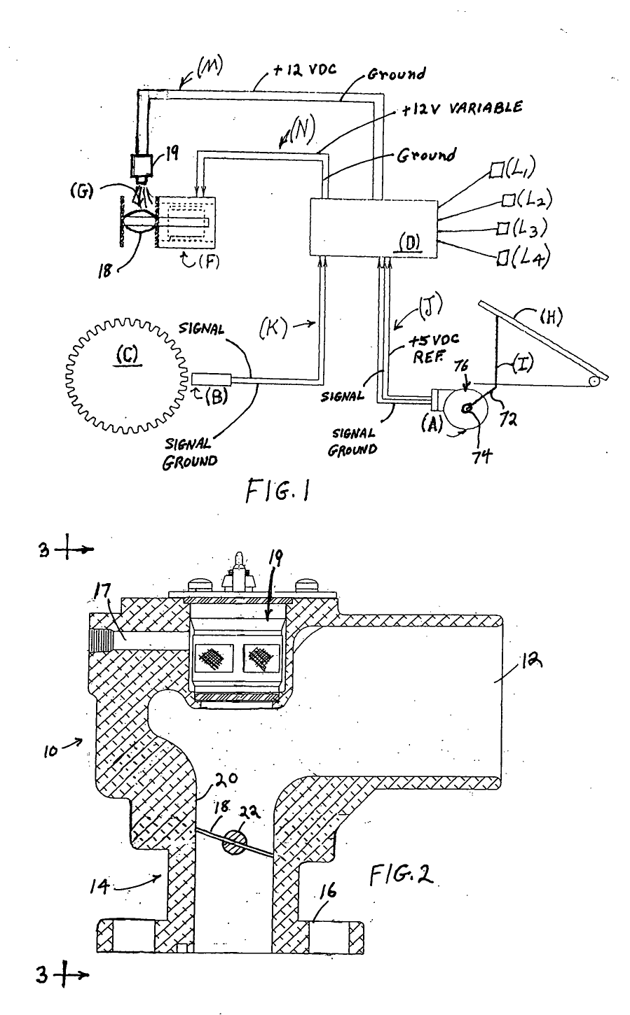

### DESCRIPTION OF THE MAIN COMPONENTS REFERRING TO THE BELOW SCHEMATIC.

Vehicle Components

1. Vehicle foot accelerator pedal (H).
2. Transmission/final drive or sensing gear (C).
   Sensor
1. Speed demand or request sensor (A) attached to (H).
2. Ground speed sensor (B) installed adjacent sensing gear.
   Electronic Fuel Systems
1. Electronic control module, ECM (D).
2. Fuel injector(s)/fuel trim device (E) installed on air intake side of engine to meter fuel delivery.
3. Throttle body valve or plate (G) installed in the throttle body assembly.
4. Electronic governor (F) installed at the throttle body assembly and linked to the throttle body valve (plate) (G).

### Some Principal Advantages of the Invention

a) The ground speed control is performed without significantly altering the chemical composition of the exhaust emissions. For industrial vehicle applications, the ground speed control feature will allow the engine to deliver maximum horsepower (on demand), including and up to reaching the limiting ground speed.
b) For Forklift applications and to comply with safety regulations the ground speed control feature can be invoked also by a second sensor on the forklift mast, sending signals to the (ECM to limit the vehicle ground speed and/or the lifting speed according to the forklift height position.
c) The ground speed control provides vehicles with the ability to climb grades without a reduction in performance, while still maintaining a maximum travel speed once achieved.

### Main Applications:

(a) Forklifts
(b) Aerial Lifts and Cranes
(c) Baggage Handlers
(d) Ground transportation equipment
(e) Utility vehicles

In one preferred embodiment of the present apparatus wherein the ground speed of a vehicle such as a forklift truck is to be automatically controlled in certain situations which present unusual or dangerous conditions, the apparatus comprises an accelerator foot pedal (H) or equivalent which is linked by (I) to a speed request sensor (A) electronically linked by conductor means (J) to ECU which is an electronic control unit a)) such that the position of (ID as depressed by an operator can be immediately transmitted by electronic signal to (D), a real time ground speed sensor (B) is adapted to electronically pick off real time vehicle ground speed from, e.g., the final drive gear (C) of the transmission and then transmit a representative signal of said ground speed via conductor means (K) to ()), one or more condition sensors such as (L), (L₂), (L₃) and (L₄) which continually feed electronic condition signals representative, e.g., of engine or vehicle conditions or states to D, wherein D is programmed to process such signals and correlate them with signals from (A) and (B) and with pre-programmed limiting operational conditions, an electronically controlled fuel injector/fuel trim device (E) mounted in the air intake system of the vehicle and electronically connected to (D) by conductor means (M), and actuable by signals from (D) to regulate fuel flow to the engine, and an electronically operated governor (F) electronically connected to (D) by conductor means (N) and actuable by signals from (D) to adjust the position of the throttle body plate (valve) (G) to thereby regulate air flow to the engine and thus regulate engine rpm and vehicle ground speed.

Referring to FIGS. 2 and 3 of the drawings, a tried and tested LP (propane) fuel injection system is shown as comprising a generally conventional carburetor housing 10 having an air inlet 12 adapted for connection to an air filter (not shown) of any conventional type, and having a throat or throttle portion 14 adapted by bolt flange 16 for connection to the intake manifold of an internal combustion engine in conventional manner. A LP gas inlet 17, e.g., 15-psi propane, communicates with an LP gas injector 19.

A throttle plate 18 is mounted in throat 20 on shaft 22 which is fixed in an armature 24 rotatable in a stator 26 of an electric motor or actuator, whereby electrical signals received from the ECU unit can rotate the shaft and position (angularly) the throttle plate 18 anywhere between fully closed and fully opened. Torsion spring 28 is used to rotationally urge the shaft toward its closed position whereby the engine would shut down in the event of some mishap which could result in a runaway engine.

A MAP sensor 30 is shown in FIG. 3 and communicates thru passageway 32 with intake throat 20. For proper speed (rpm) control of an engine under varying loads, the electronic control unit ECU) estimates the mass flow of air entering the cylinders. The volume flow of air, measured in cubic feet per minute, is proportional to engine speed in revolutions per minute. To determine the mass flow, the volume flow is multiplied by the air density. The air density is determined from the manifold absolute pressure (MAP) and the air temperature. Sensors measure each of these and allow air density to be calculated.

Referring to FIGS. 4 and 2, the LP gas injector 19 comprises a body 34, coil 36, pole piece 38, seat 40, shim and armature assembly 42, armature ring 44, filter 46, adjusting plug 48, spring 50, adjusting screw 52, O-ring 54, O-ring 56, and O-ring 58.

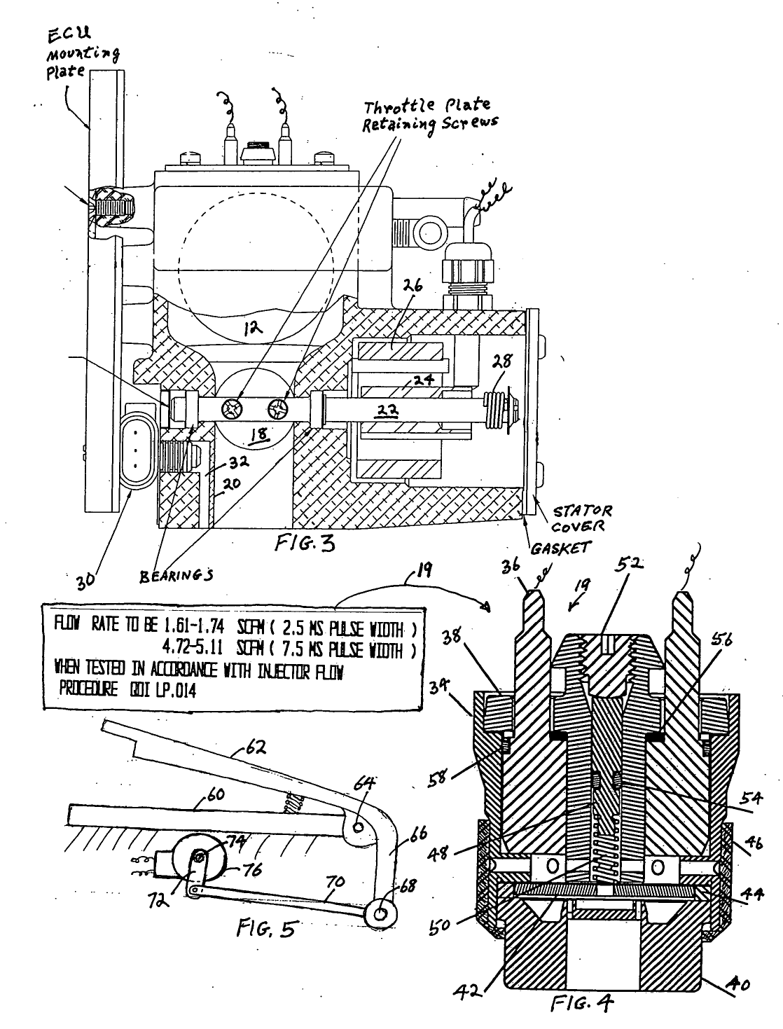

Referring to FIG. 5, a useful type of accelerator pedal is shown and comprises a base 60 to which a foot pedal 62 is pivotally mounted by shaft 64. A downwardly projecting segment 66 on the rear of the pedal is pivotally mounted by a pin 68 to a rod 70 which is pivotally mounted on an arm segment 72 affixed to a shaft 74 of a potentiometer 76. This potentiometer, upon rotation of shaft 74, will give a voltage signal to the ECM. This particular type of electronic pedal uses a 0-5 VDC +/−0.05 VDC supply voltage, 20 MA supply current, an end to end 2.5 K Ohms sensor resistance, 3 and 6 pin sensors, and a power rating of 0.05 watts.

### Field Experience

(a) Some industrial vehicles applications require a ground speed control and this function becomes very critical when some of this equipment is operated in areas where there is no ground speed monitoring or supervision.
(b) One of the main purposes of this invention is to limit the vehicle ground speed to a maximum pre-set speed level, which is defined within safety parameters for the particular environment in which the vehicle is operating.
(c) For any given condition of the engine rpm or engine load, the (ECM) will maintain the ground speed of the vehicle without interfering with its normal operation and performance.
(d) This invention will reduce the level of related injuries and the insurance premiums associated with industrial and off highway usages.
(e) This invention provides a tamper resistance property, in which field personnel cannot alter or change operating characteristics of the vehicle.

The invention has been described in detail with particular reference to preferred embodiments thereof, but it will be understood that variations and modifications will be effected with the spirit and scope of the invention.

1. The method for controlling ground speed and auxiliary implements operating speeds of industrial vehicles, comprising:
(1) providing on a vehicle an (ECM) which is programmed to receive signals of various real time operational speeds of a vehicle and correlate them with limiting operational speeds of said vehicle which are pre-programmed into said (ECM), wherein said vehicle is powered by an internal combustion engine which is provided with carburetion means having a throttle plate, and an electronic governor which can, upon receiving an electronic signal from said (ECM), regulate the position of said throttle plate and thus the air flow to the engine whereby to control engine rpm,
(2) sensing the desired operational speeds sought by the vehicle operator thru the positions of an accelerator means operated by the operator, and transmitting electronic signals representative of said position to said (ECM),
(3) sensing the real time operational speeds and transmitting electronic signals representative thereof to said (ECM), and
(4) directing said (ECM) to correlate said signals of real time operational speeds with said desired operational speeds and said limiting operational speeds and generate and transmit electronic signals to said governor to regulate air flows to said engine to attain certain engine rpm's and thus real time operational speeds in accord with said desired operational speeds.

2. The method of claim 1 wherein said vehicle is a forklift type vehicle.

3. The method of claim 1 wherein the fuel is LP gas and the carburetion means utilizes electronically operated gas injector means.

4. The method of claim 1 wherein the fuel is petroleum and the carburetion means utilizes electronically operated liquid fuel injector means.

5. The method of claim 1 wherein said real time operational speeds are the vehicle real time ground speeds and/or the auxiliary implement real time operational speeds.

6. The method of claim 1 wherein real time ground speed is electronically picked off of the final drive gear of the vehicle transmission by a speed sensor (B).

7. A ground speed control system for a vehicle having an internal combustion engine and an accelerator foot pedal (H), wherein said pedal is linked by (I) to a speed request sensor (A) electronically linked by conductor means (J) to ECU which is an electronic control unit (D), such that the position of (H) can be immediately transmitted by electronic signal to (D), a real time ground speed sensor (B) is adapted to electronically transmit a representative signal of said ground speed via conductor means (K) to (D), one or more condition sensors such as (L), (L₂), (L₃) and (L₄) which continually feed electronic condition signals representative of engine or vehicle conditions or states to D, wherein D is programmed to process such signals and correlate them with signals from (A) and (B) and with pre-programmed limiting operational conditions, an electronically controlled fuel injector/fuel trim device (E) mounted in the air intake system of the vehicle and electronically connected to (D) by conductor means (M), and actuable by signals from (D) to regulate fuel flow to the engine, and an electronically operated governor (F) electronically connected to (D) by conductor means (N) and actuable by signals from (D) to adjust the position of the throttle body valve (G) to thereby regulate air flow to the engine and thus regulate engine rpm and vehicle speed.

8. The system of claim 7 wherein a speed sensor (B) is positioned adjacent the final drive gear (C) of the vehicle transmission to thereby electronically pick off the real time vehicle ground speed.
